(19) United States
(12) Patent Application Publication
(10) Pub. No.: US 2002/0008732 A1
(43) Pub. Date: Jan. 24, 2002

(54) Ink-jet printhead

(76) Inventors: Jae-Ho Moon, Suwon-city (KR); Dae-Soon Lim, Yongin-city (KR)

Correspondence Address: ROBERT E. BUSHNELL, 1522 K STREET NW, SUITE 300, WASHINGTON, DC, 200051202

(21) Appl. No.: 09/782,029

(22) Filed: Feb. 14, 2001

(30) Foreign Application Priority Data
Jul. 20, 2000 (KR) 00-41748

(51) Int. Cl. B41J 2/14

(52) U.S. Cl. 347/48

(57) ABSTRACT

An ink-jet printhead is provided. The ink-jet printhead includes: a substrate, on the rear surface of which a channel having a bottom is formed with a predetermined depth, wherein a plurality of ink feed holes are formed on the bottom of the channel; a nozzle plate which is coupled to a front surface of the substrate and on which a plurality of chamber-orifice complex holes are formed, wherein each chamber-orifice complex hole corresponds to one or more ink feed holes among the plurality of ink feed holes; and a plurality of heaters which is formed on the front surface of the substrate corresponding to the chamber-orifice complex holes, respectively. Accordingly, the ink-jet printhead can effectively increase ink ejection pressure by effectively suppressing a back flow of ink, while providing for a high resolution image by making the volume of a droplet uniform or very small. Further, the ink feed hole is provided for each chamber-orifice complex hole, thereby preventing degradation in the physical strength of the substrate. In particular, the structure of a channel for supplying ink is significantly simplified.

### CLAIM OF PRIORITY

This application makes reference to, incorporates the same herein, and claims all benefits accruing under 35 U.S.C. §119 from my application entitled INK JET PRINT HEAD filed with the Korean Industrial Property Office on Jul. 20, 2000 and there duly assigned Serial No. 2000/41748.

### BACKGROUND OF THE INVENTION

1. Field of the Invention

The present invention relates to an ink-jet printhead, and more particularly, to an ink-jet printhead for effectively preventing a back flow of ink due to the expansion pressure of a bubble.

2. Description of the Related Art

The ink ejection mechanisms of an ink-jet printer are largely categorized into two types: an electro-thermal transducer type (bubble-jet type) in which a heat source is employed to form a bubble in ink causing ink droplets to be ejected, and an electro-mechanical transducer type in which a piezoelectric crystal bends to change the volume of ink causing ink droplets to be expelled.

An ideal ink-jet printer 1) is easy to manufacture, 2) produces high quality color images, 3) the effects of crosstalk between nozzles is minimized, 4) can print at high speeds, and 5) doesn't get clogged with foreign material or solidified ink. What is needed is an ink-jet printer that achieves all of these criteria.

### SUMMARY OF THE INVENTION

It is therefore an object of the present invention to provide an ink-jet printhead for effectively increasing the ejection pressure of ink while effectively preventing a back flow of the ink.

It is another object of the present invention to provide an ink-jet printhead that allows for a high resolution image by making the volume of a droplet uniform and smaller.

It is still another object of the present invention to provide an ink-jet printhead that suppresses the physical strength of a substrate from being weakened while simplifying the structure of an ink channel.

It is yet still another object of the present invention to provide an ink-jet printhead that can prevent the occurrence of cross-talk between ink chambers.

These and other objects can be achieved by an ink-jet printhead including: a substrate, on the rear surface of which a channel having a bottom is formed with a predetermined depth, wherein a plurality of ink feed holes are formed on the bottom of the channel; a nozzle plate which is coupled to a front surface of the substrate and on which a plurality of chamber-orifice complex holes are formed, wherein each chamber-orifice complex hole corresponds to one or more ink feed holes among the plurality of ink feed holes; and a plurality of heaters which are formed on the front surface of the substrate corresponding to the chamber-orifice complex holes, respectively. The ink feed hole is formed at the center portion of a region corresponding to the chamber-orifice complex hole, and the heater is formed in an annular shape which surrounds the ink feed hole. In particular, the annular heater is of a substantially omega shape.

The heater is formed at the center portion of a region corresponding to the chamber-orifice complex hole and the ink feed hole is formed on one or both sides of the heater. The chamber-orifice has a truncated conical shape, wherein one portion opposing the heater includes the corresponding ink feed hole and heater formed on the substrate and the other portion having a smaller diameter faces toward the outside. In particular, the large diameter portion of the chamber-orifice complex hole includes a cylindrical portion having a predetermined diameter.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIGS. 1A and 1B are cross-sectional views showing the structure of a conventional bubble-jet type ink-jet printhead and an ink ejection mechanism therefor;

FIG. 2 is a perspective view of a portion of a conventional bubble-jet type ink-jet printhead;

FIG. 3 is a schematic cross-sectional view showing the structure of the conventional bubble-jet type ink-jet printhead shown in FIG. 2;

FIG. 4 is a schematic top view showing the structure of the conventional bubble-jet type ink-jet printhead shown in FIG. 2;

FIG. 5 is a perspective view of a portion of another conventional bubble-jet type ink-jet printhead;

FIG. 6 is atop view of an entire substrate applied to an ink-jet printhead according to a first embodiment of the present invention;

FIG. 7 is an enlarged view of a portion A of FIG. 6;

FIG. 8 is a cross-sectional view taken along line III-III of FIG. 7, whichshows a state in which the nozzle plate is attached to the substrate;

FIG. 9 is a cross-sectional view taken along line IV-IV of FIG. 7, which shows a state in which the nozzle plate is attached to the substrate;

FIG. 10 is a rear view showing the rear surface of the substrate applied to the ink-jet printhead according to the first embodiment of the present invention;

FIG. 11 is a cross-sectional view taken along line VI-VI of FIG. 10;

FIG. 12 is a perspective view showing a unit ink ejection structure in the ink-jet printhead according to the first embodiment of the present invention shown in FIGS. 6-11;

FIGS. 13-15 show the steps of an ink ejection process in the unit ink ejection structure of the ink-jet printhead according to the first embodiment of the present invention shown in FIGS. 6-11;

FIG. 16 is a cross-sectional view of a portion of a substrate applied to an ink-jet printhead according to a second embodiment of the present invention;

FIG. 17 is a perspective view of the portion of the substrate applied to the ink-jet printhead according to the second embodiment of the present invention shown in FIG. 16;

FIGS. 18-20 show the steps of an ink ejection process in a unit ink ejection structure of the ink-jet printhead according to the second embodiment of the present invention shown in FIGS. 16 and 17;

FIG. 21 is a perspective view of a portion of an ink-jet printhead according to a third embodiment of the present invention;

FIG. 22 is a top view showing the arrangement structure of a heater and an ink feed hole formed on a substrate in an ink-jet printhead according to a fourth embodiment of the present invention; and

FIG. 23 is a top view showing the arrangement structure of a heater and an ink feed hole formed on a substrate in an ink-jet printhead according to a fifth embodiment of the present invention.

### DETAILED DESCRIPTION OF THE INVENTION

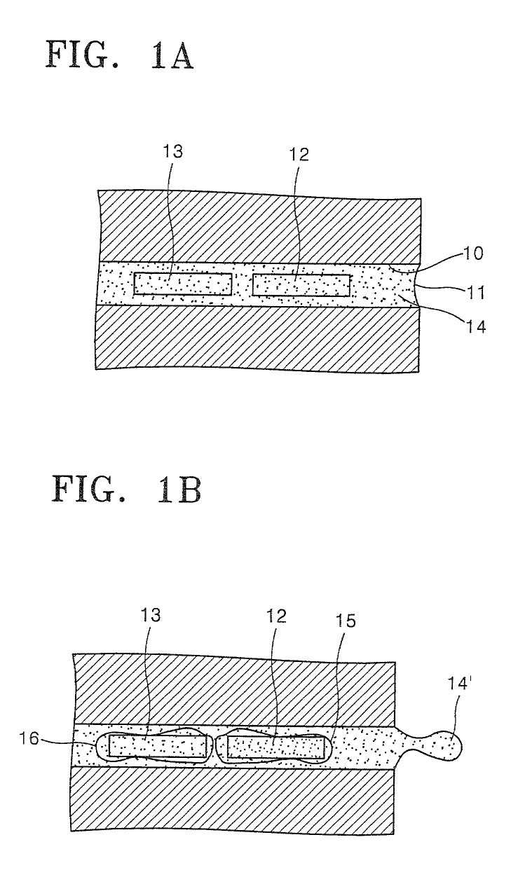

Referring to FIGS. 1A and 1B, a general bubble-jet type ink ejection mechanism will now be described. When a current pulse is applied to a first heater 12 consisting of resistive heating elements formed in an ink channel 10 where a nozzle 11 is located, heat generated by the first heater 12 boils ink 14 to form a bubble 15 within the ink channel 10, which causes an ink droplet 14′ to be ejected.

In FIGS. 1A and 1B, a second heater 13 is provided so as to prevent a back flow of the ink 14. First, the second heater 13 generates heat, which causes a bubble 16 to shut off the ink channel 10 behind the first heater 10. Then, the first heater 12 generates heat and the bubble 15 expands to cause the ink droplet 14′ to be ejected.

Meanwhile, an ink-jet printhead having this bubble-jet type ink ejector needs to meet the following conditions. First, a simplified manufacturing process, low manufacturing cost, and high volume production must be allowed. Second, to produce high quality color images, creation of minute satellite droplets that trail ejected main droplets must be prevented. Third, when ink is ejected from one nozzle or ink refills an ink chamber after ink ejection, cross-talk with adjacent nozzles from which no ink is ejected must be prevented. To this end, a back flow of ink in the opposite direction of a nozzle must be avoided during ink ejection. Another heater shown in FIGS. 1A and 1B is provided for this purpose. Fourth, for a high speed print, a cycle beginning with ink ejection and ending with ink refill must be as short as possible. Fifth, a nozzle and an ink channel for introducing ink into the nozzle must not be clogged by foreign materials or solidified ink.

However, the above conditions tend to conflict with one another, and furthermore, the performance of an ink-jet printhead is closely associated with structures of an ink chamber, an ink channel, and a heater, the type of formation and expansion of bubbles, and the relative size of each component.

In efforts to overcome problems related to the above requirements, ink-jet print heads having a variety of structures have been proposed in U.S. Pat. Nos. 4,339,762; 4,882,595; 5,760,804; 4,847,630; and 5,850,241, European Patent No. 317,171, and Fan-Gang Tseng, Chang-Jin Kim, and Chih-Ming Ho, “A Novel Micoinjector with Virtual Chamber Neck”, IEEE MEMS '98, pp. 57-62. However, ink-jet printheads proposed in the above patents or literature may satisfy some of the aforementioned requirements but do not completely provide an improved ink-jet printing approach.

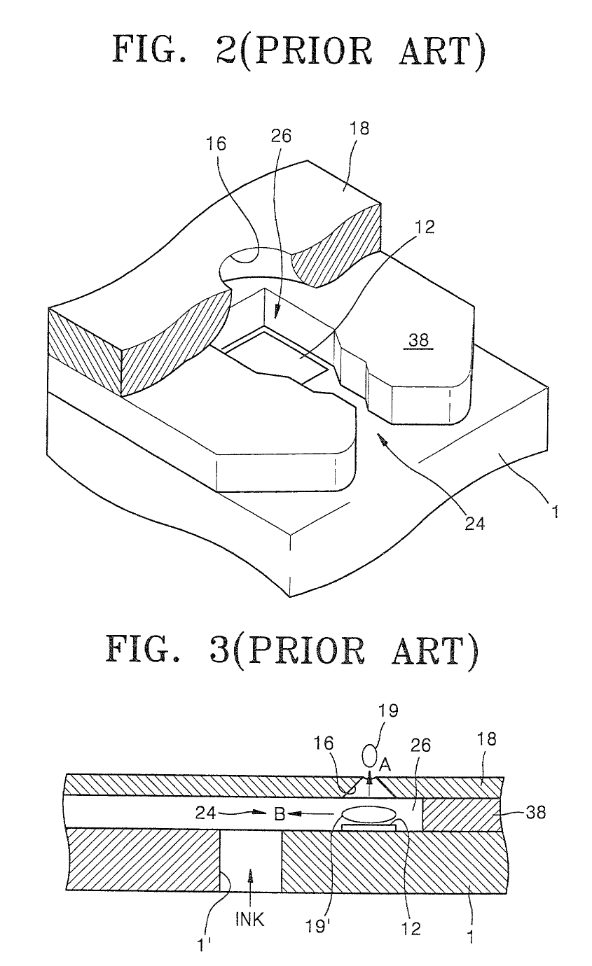

FIG. 2 is an extract drawing showing an ink-jet printhead disclosed in U.S. Pat. No. 4,882,595. Referring to FIG. 2, a chamber 26 for providing for a space where a heater 12 formed 4 on a substrate 1 is located, and an intermediate layer 38 for forming an ink feed channel 24 for introducing ink into the chamber 26 are provided. A nozzle plate 18 having a nozzle 16 corresponding to the chamber 26 is disposed on the intermediate layer 38.

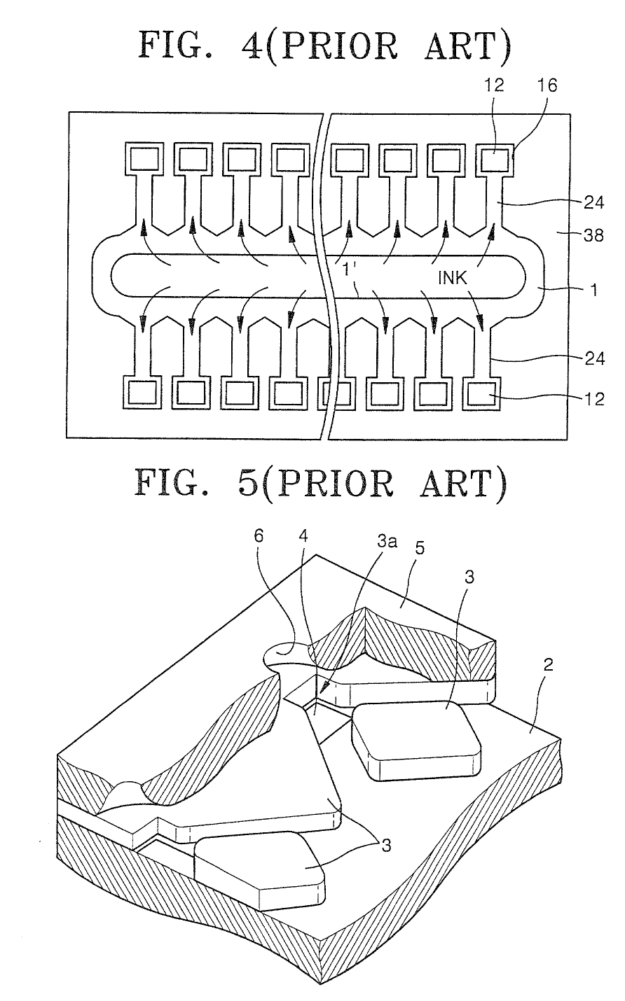

FIG. 3 is a cross-sectional view of the conventional ink-jet printhead shown in FIG. 2, and FIG. 4 is a schematic top view showing a structure in which ink is supplied to each chamber of the conventional ink-jet printhead shown in FIG. 2. First, referring to FIG. 3, an ink feed channel 24 extends parallel to the nozzle plate 18 and the substrate 1. The direction in which a droplet 19 is ejected is vertical to the substrate 1. Three sides of the ink chamber 26, in which the heater 12 is located, are closed by the intermediate layer 38. A through hole 1′ for penetrating the substrate 1 is formed at a front end of the ink feed channel 24.

Thus, according to the above structure, when a bubble 19′ is formed by the heater 12, the expansion pressure of the bubble 19′ is exerted on the ink feed channel 24 parallel to the substrate and the nozzle 16 vertical thereto. Thus, ink ejection pressure by the bubble 19′ is dispersed in two directions, that is, the ink feed channel 24 and the nozzle 16, so that the ejection pressure by the bubble 19′ or expansion pressure of the bubble 19′ that contributes to the ejection of the droplet 19 is reduced by about 50%.

Referring to FIG. 4, the conventional ink-jet printhead described above is constructed such that the ink chambers 26 are arranged parallel to each other at either side of the substrate 1, and the one-directionally elongated through hole 1′ for introducing ink is formed between the ink chambers 26. The through hole 1′ is formed with a length sufficient to substantially transverse the center portion of the substrate 1 thereby degrading the overall structural strength of the substrate 1. The through hole 1′ is typically manufactured by sand blasting, during which a cleaning process for removing particles is required.

Furthermore, while an adhesive tape is applied as the intermediate layer 38 disposed between the nozzle plate 18 and the substrate 1, lifting between the substrate 1 and the intermediate layer 38 occurs due to the step difference formed by electrodes on the substrate 1. In particular, the top surface of the intermediate layer 38 is rough with rounded corners due to overetching and hence the area in contact with the nozzle plate 18 becomes smaller than a design value. Thus. the nozzle plate 18 and the intermediate layer 38 do not adhere to each other with a sufficient area thereby degrading the adhesive force therebetween.

FIG. 5 is an extract drawing showing an ink-jet printhead disclosed in U.S. Pat. No. 5,912, 685. Referring to FIG. 5, an ink chamber 3a in which a heater resistor 4 is disposed, and an intermediate layer 3 for offering an ink channel for introducing ink into the ink chamber 3a are disposed on a substrate 2. A nozzle plate 5 including a nozzle 6 corresponding to the chamber 3a is formed on the intermediate layer 3.

In the ink-jet printheads shown in FIGS. 2-5, one chamber is allocated for each nozzle and an ink channel having a complicated structure is provided for supplying ink from an ink feed cartridge to each chamber. Also, as previously mentioned, the structural hardness of the structure is weakened by the through hole formed on the substrate and hence the substrate needs to be carefully handled.

Thus, due to the complicated structures of the conventional ink-jet printheads, the fabrication process is very complex and the manufacturing cost is very high. Furthermore, each ink channel having the complicated structure makes fluid resistance to ink supplied to each chamber different, which results in large difference in the amount of ink supplied to each chamber. Thus, this raises design problems with adjusting the difference.

### Embodiment 1

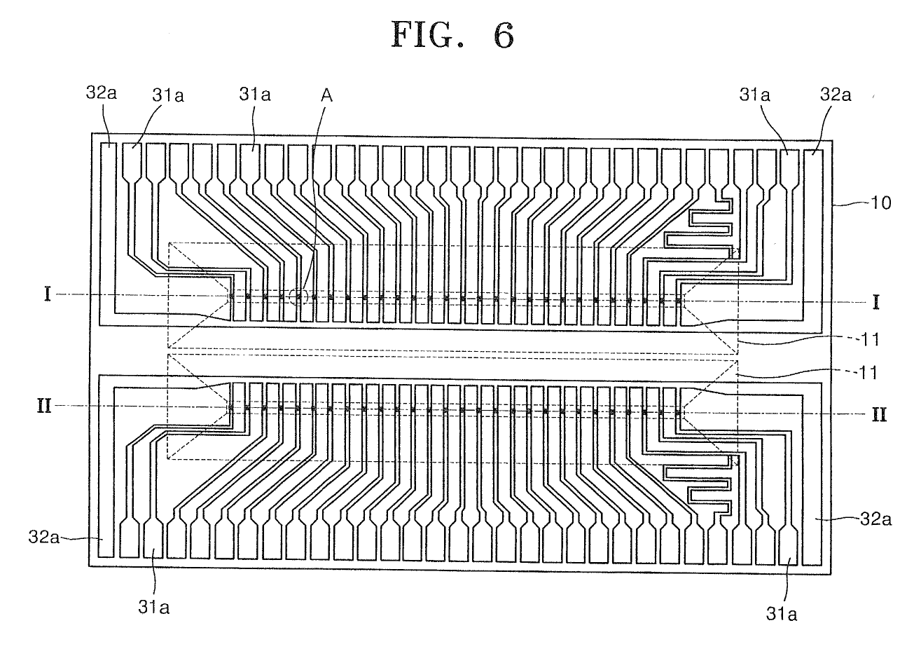

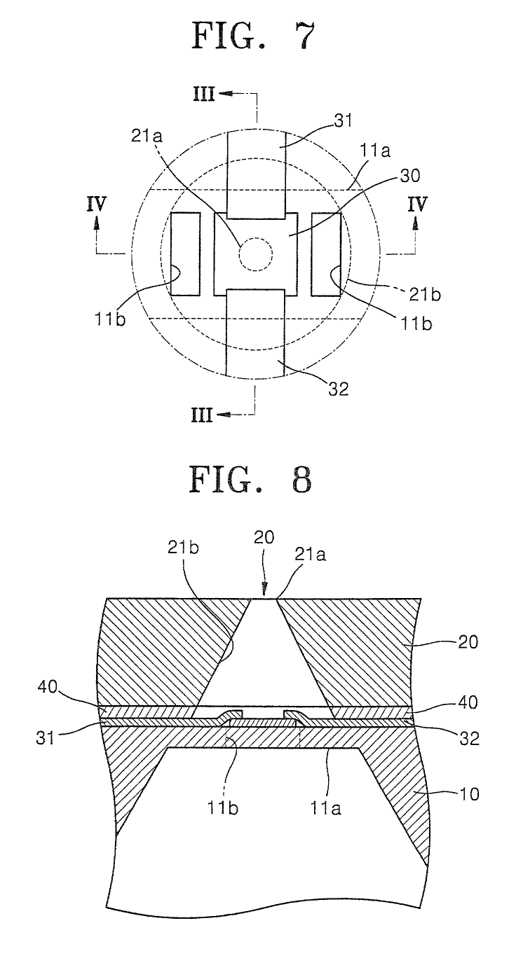

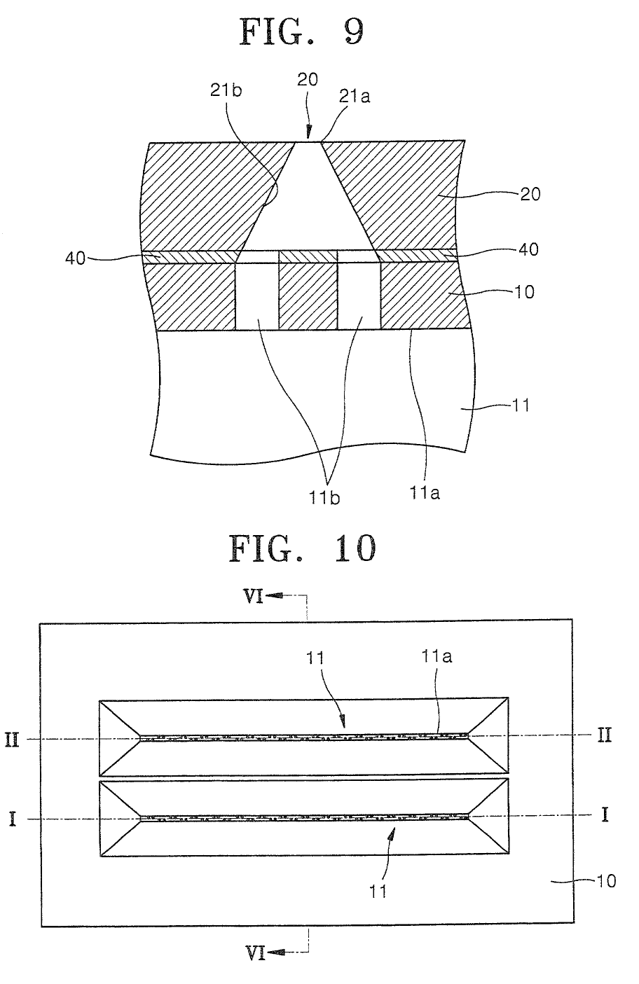

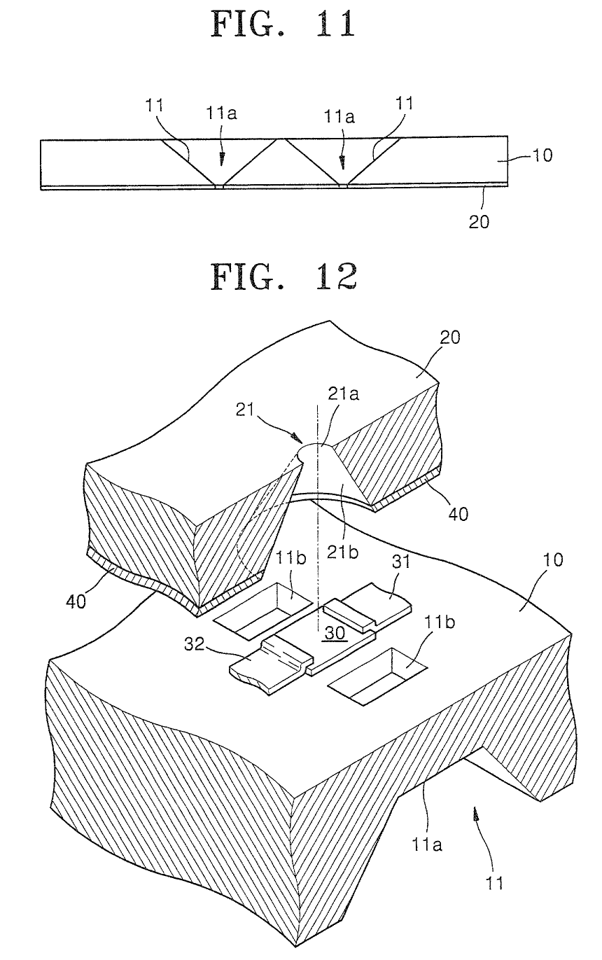

FIG. 6 are a top view showing the structure of a substrate 10 fabricated through silicon wafer processing, and FIG. 7 is an enlarged view of a portion “A”. FIG. 8 is a cross-sectional view taken along line III-III of FIG. 7, which shows the structure of one chamber-orifice complex hole when a nozzle plate 20 is combined. FIG. 9 is a cross-sectional view taken along line IV-IV of FIG. 7, which shows the structure of one chamber-orifice complex hole when the nozzle plate 20 is combined. FIG. 10 is a bottom view showing the structure of a channel 11 formed on the bottom of the substrate 10, and FIG. 11 is a cross-sectional view taken along line VI-VI of FIG. 10. FIG. 12 is a perspective view showing an ink ejection structure having the chamber-orifice complex hole and the heater corresponding thereto in the ink-jet printhead according to the first embodiment of the present invention.

Referring to FIGS. 6 and 7, a plurality of heaters 30 are arranged at regular intervals on arbitrary lines I-I and II-II that extend in the longitudinal direction of a substrate 10 and are spaced apart from each other by a predetermined distance. As shown in FIGS. 9 and 10, the lines I-I and II-II pass through the center portions of the bottoms 11a of two narrow and long V-shaped channels 11 formed parallel to each other on the rear surface of the substrate 10 in a longitudinal direction, and thus the heaters 30 are formed at positions corresponding to the bottoms 11a of the V-shaped channels 11.

As shown in FIGS. 6, 7, and 12, first and second signal lines 31 and 32 formed of a conductive material such as aluminum are coupled to both ends of each heater 30. The first and second signal lines 31 and 32 are coupled to electrode pads 31a and 32a, respectively. Here, the 8. second signal lines 32 are commonly coupled to one common electrode pad 32a.

Meanwhile, as shown in FIGS. 7, 8, 9, and 12, each chamber-orifice complex hole 21 is formed on the nozzle plate 20 in the form of a circular cone which includes a large diameter portion 21b surrounding the heater 30 and the link feed hole 11b formed on both sides of the heater 30 and a small diameter portion 21a disposed opposite the large diameter portion 21b for ejecting ink. The nozzle plate 20 is attached to the substrate 10 by an adhesive layer 40. The nozzle plate 20 may be formed of Ni or polyimide.

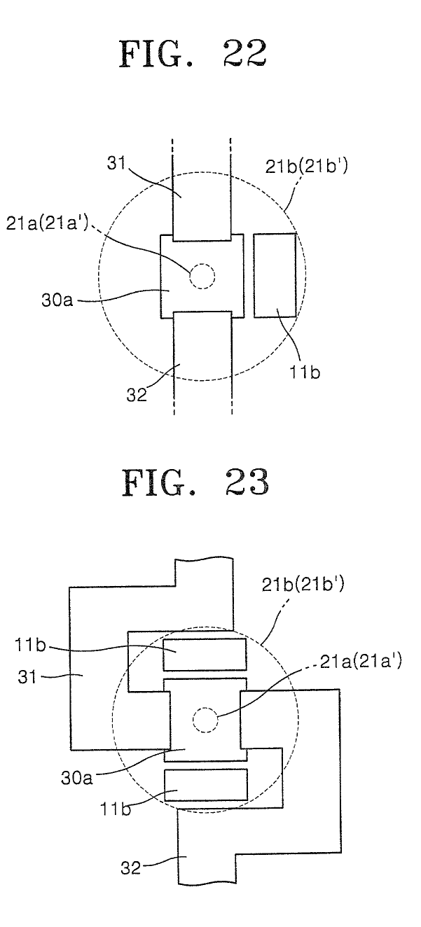

In the structure in which one heater 30 and two ink feed holes 11b are provided for each chamber-orifice complex hole 21, either of the ink feed holes 11b may be omitted (See FIG. 22), but preferably the ink feed holes 11b may be provided on both sides of the heater 30 as described above.

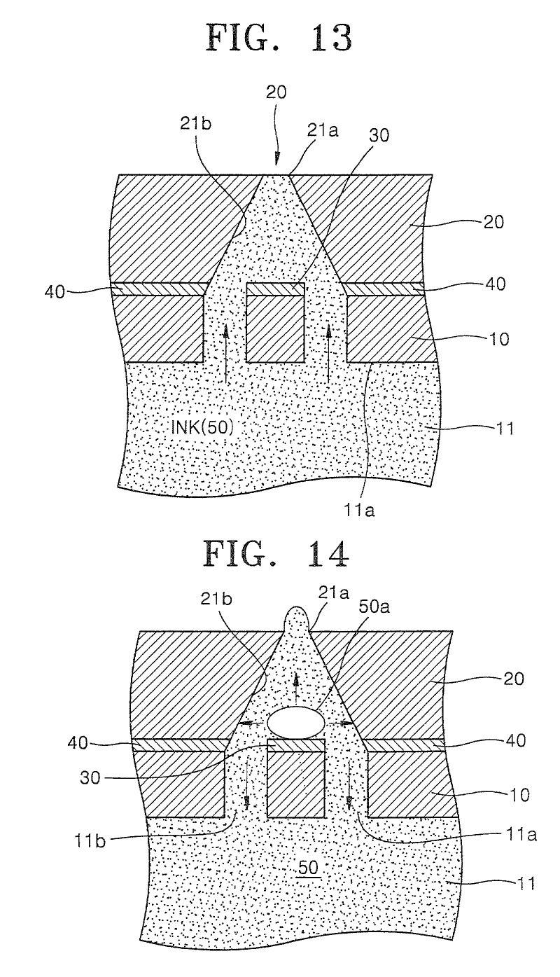

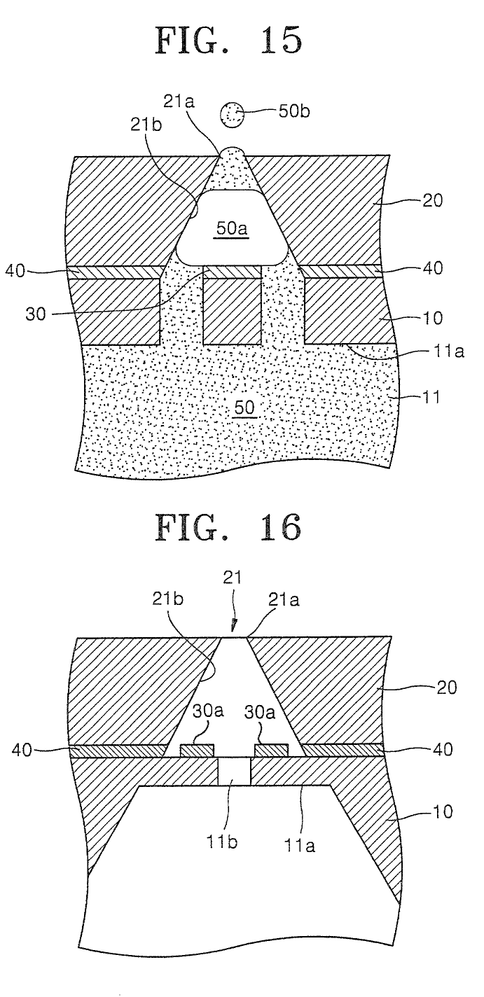

An ink ejection mechanism in the ink-jet printhead according to the first embodiment of the present invention having the structure as described above will now be described. As shown in FIG. 13, ink is supplied through the channel 11 and the ink feed hole 11b formed on the bottom of the channel 11. The nozzle plate 20 is disposed above the substrate 10 in FIG. 13 for better visualization, but is disposed below the substrate 10 when it is actually installed in a printer. Thus, ink 50 supplied to the channel 11 from an ink reservoir (not shown) is introduced into the chamber-orifice complex hole 21 through the ink feed hole 11b by gravity and capillary action. When a voltage is applied across the heater 30 on the substrate 10 within the corresponding chamber-orifice complex hole 21, heat is rapidly generated to boil ink in contact with the heater 30 thereby forming a bubble 50a as shown in FIG. 14. The bubble 50a grows while heat generation by the heater 30 continues. Thus, the bubble 50a exerts pressure on the ink 50 present in the chamber-orifice complex hole 21 by the bubble 50a, so that the ink 50 starts to flow into the small diameter portion 21a and the ink feed holes 11b on both sides of the heater 30 of the chamber-orifice complex hole 21. The bubble 50a grows very fast to reach its maximum growth within the chamber orifice complex hole 21 thereby blocking the ink feed holes 11b on both sides of the heater 30 excluding the small diameter portion 21a (see FIG. 15). Thus, the ink 50 present in the chamber-orifice complex hole 21 is ejected in droplets 50b mainly through the small diameter portion 21a.

The ink-jet printhead according to the present invention allows the bubble 50a that generates ejection energy for the ink 50 to quickly block the ink feed holes 11b, where a back flow of ink occurs, when ejection of the ink droplet 50b begins, thereby suppressing the back flow of the ink 50 toward the channel 11 as much as possible.

On the other hand, when a voltage ceases to be applied to the heater 30, the bubble 50a collapses within a short time and hence the ink 50 refills from the channel 11 to the chamber-orifice complex hole 21 by gravity and capillary action.

According to this invention, the ink 50 for the droplet 50b is supplied to the chamber orifice complex hole 21 formed in the nozzle plate 20, thereby making it possible to generate the droplet 50b having a very small volume and finely adjust the volume. Thus, the present invention allows for high resolution printing. In particular, most amount of ink 50 is ejected through the small diameter portion 21a by quickly closing an ink feed passageway, that is, the ink feed holes 11b by the bubble 50a, thus allowing for high efficiency in ink ejection. Furthermore, a relatively large volume of ink droplet 50b can be obtained in a small volume of chamber, compared to a conventional ink-jet printhead. Furthermore, the ink feed holes 11b are provided for each chamber orifice complex hole 21 thereby significantly reducing degradation in the physical strength of the substrate 10 compared to a conventional ink-jet printhead.

### Embodiment 2

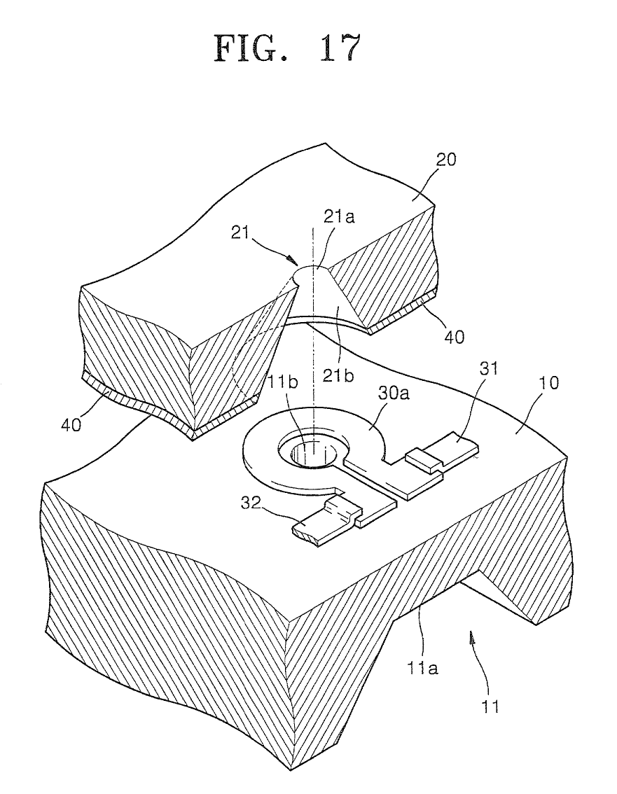

FIG. 16 is a schematic cross-sectional view of a portion of an ink-jet printhead according to a second embodiment of the present invention, and FIG. 17 is a perspective view showing a state in which the nozzle plate 20 is separated from the substrate 10. Referring to FIGS. 16 and 17, a heater 30a is doughnut-shaped or omega-shaped, the ends of which is coupled to first and second signal lines 31 and 32. An ink feed hole 11b connected to a channel 11 is formed inside the heater 30a. The features of this embodiment are that the ink feed hole 11b is disposed corresponding to the center portion of a chamber-orifice complex hole 21 and the heater 30a encircles the ink feed hole 11b. Thus, the heater 30a may have a polygonal frame shape such as tetragonal or pentagonal frame as well as a doughnut shape, one side of which is open.

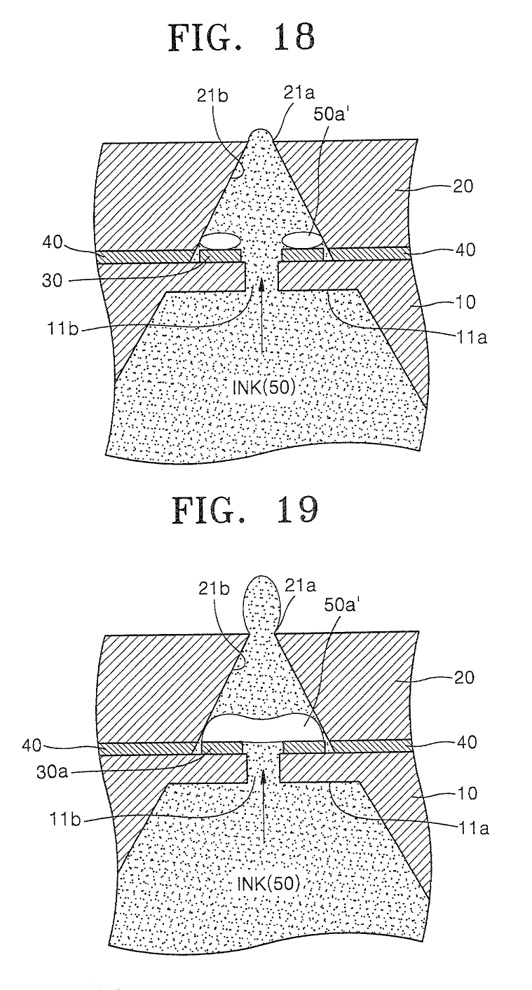

As shown in FIG. 18, when a voltage is applied across the heater 30a, heat is rapidly generated to form a bubble 50a′ on the surface of the heater 30a. In this case, the bubble 50a′ is formed with a shape corresponding to the shape of the heater 30a, such as a doughnut shape or polygonal shape such as a tetragon or pentagon. While the back flow of a very small amount of ink occurs through the ink feed hole 11b at an early stage when the bubble 50a′ is generated, most ink flows toward a small diameter portion 21a, that is, in the direction in which ink is ejected. Thus, a small amount of ink is expelled to the ink feed hole 11b.

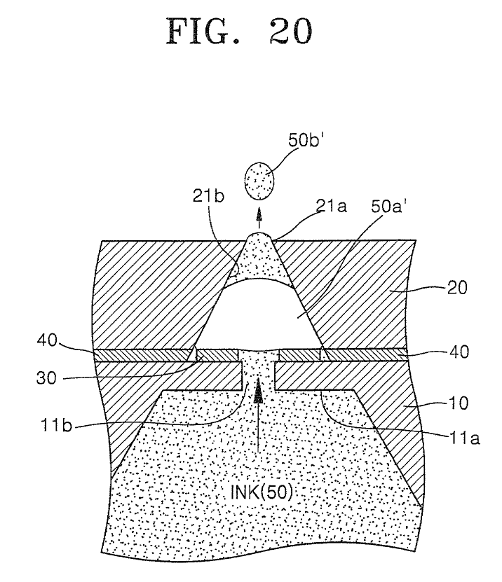

As shown in FIG. 19, when a voltage continues to be applied to the heater 30a, the bubble 50a′ grows to close the ink feed hole 11b thereby starting ink ejection. In this case, the pressure due to the growth of the bubble 50a′ is all generated toward the small diameter portion 21a. When the bubble 50a′ is fully grown within the chamber-orifice complex hole 21 as shown in FIG. 20, a droplet 50b′ is ejected through the small diameter portion 21a. Then, when a voltage ceases to be applied to the heater 30a, the bubble 50a′ collapses within a short time and returns to an initial state.

### Embodiment 3

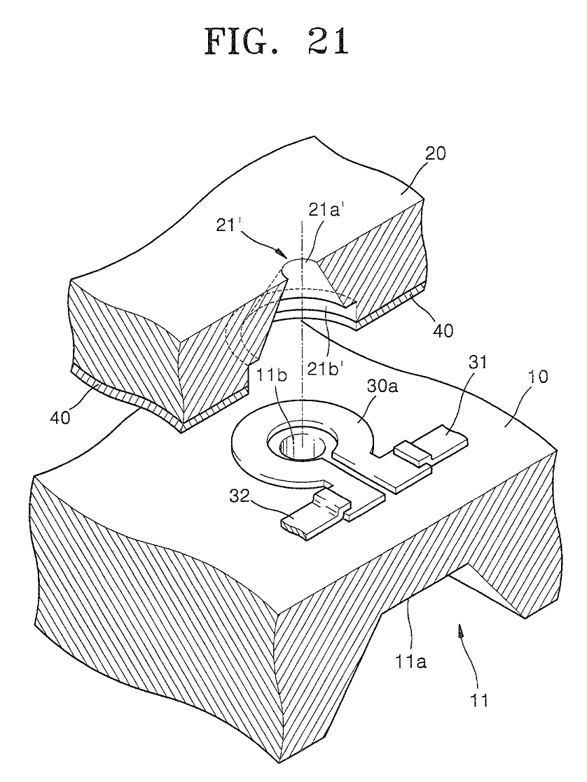

FIG.21 is a modified example for the second embodiment, which shows a structure having a expanded chamber 21b′ at the lower portion of the chamber-orifice complex hole 21′. According to this embodiment, the expanded chamber 21b′ is provided at the lower portion of the chamber-orifice complex hole 21′, that is, a large diameter portion 21b′. The expanded chamber 21b′ includes a cylindrical wall to provide for bubble expansion. The expanded chamber 21b′ is applicable to the first embodiment as well.

FIGS. 22 and 23 show modified examples of the arrangement structure of the heater and the ink feed holes associated therewith and the arrangement structure of electrodes 31 and 32 for the heater described in the first embodiment. Specifically, FIG. 22 shows a structure in which an ink feed hole 11b is disposed only on one side of a heater 30a, and FIG. 23 shows a structure in which the ink feed hole 11b is disposed on both sides of the heater 30a in a direction where signal lines 31 and 32 extend. These modifications are examples of an arrangement structure that conforms to design requirements for arrangement of various components. Although the chamber-orifice complex holes are formed in two rows in the above embodiments, they may be one or three or more rows, and hence as many channels must be formed on the bottom (rear surface) of the substrate as rows of the chamber-orifice complex holes, and the channels may have a rectangular cross-section as well as the V-shaped cross-section as described above.

As described above, an ink-jet printhead according to the present invention is constructed such that a chamber for ejected ink is disposed within the chamber-orifice complex hole and ink is supplied from the channel disposed on the rear surface of the substrate through the ink feed hole disposed for each chamber-orifice complex hole. In particular, the ink feed hole is closed by the bubble generated by the heater. Thus, the ink-jet printhead according to the present invention can effectively increase ink ejection pressure by effectively suppressing a back flow of ink, while providing for a high resolution image by making the size of the droplet uniform or very small due to the chamber present in the nozzle plate. Further, the ink feed hole is provided for each chamber-orifice complex hole, thereby preventing degradation in the physical strength of the substrate due to the horizontally long ink feed channel shared by all nozzles in the conventional ink-jet printhead. In particular, the structure of a channel is extremely simplified by virtue of the ink feed hole, which is one of the main features of the ink-jet printhead according to the present invention. Furthermore, the nozzle plate is directly attached to the substrate and an ink chamber is disposed within the nozzle plate, thereby preventing the occurrence of cross-talk between ink chambers unlike the conventional ink-jet printhead.

While this invention has been described in connection with what is presently considered to be the most practical and preferred embodiments, it is to be understood that the invention is not limited to the disclosed embodiments, but, on the contrary, it is intended to cover various modifications within the spirit and scope of the appended claims.

What is claimed is:

1. An ink-jet printhead, comprising:
a substrate, having a rear surface, said rear surface having a channel having a predetermined depth, wherein a plurality of ink feed holes are formed on a bottom of the channel perforating said substrate;
a nozzle plate coupled to a front surface of the substrate, said nozzle plate being perforated by a plurality of chamber-orifice complex holes, wherein each chamber-orifice complex hole corresponds at least one of said plurality ink feed holes; and
a plurality of heaters disposed on the front surface of the substrate, each one of said plurality of heaters being located near corresponding ones of said plurality of chamber-orifice complex holes.

2. The ink-jet printhead of claim 1, wherein each one of said plurality of ink feed holes is formed at a center portion of a corresponding one of said plurality of chamber-orifice complex holes, and each one of said plurality of said heaters surrounds corresponding ones of said plurality of ink feed holes.

3. The ink-jet printhead of claim 2, wherein each one of said plurality of heaters is of an omega shape that surrounds said corresponding ink feed hole.

4. The ink-jet printhead of claim 1, wherein each one of said plurality of heaters is formed at a center portion of a region corresponding to one of said plurality of chamber-orifice complex holes and said at least one ink feed hole is formed on one side of said heater.

5. The ink-jet printhead of claim 1, wherein each one of said plurality of heaters is formed at a center portion of a region corresponding to one of said plurality of chamber-orifice complex holes and ink feed holes are formed on both sides of said heater.

6. The ink-jet printhead of claim 2, wherein each chamber-orifice has a truncated conical shape, wherein a lower end of said chamber orifice facing said substrate faces the corresponding ink feed hole and heater formed on the substrate and the other end having a smaller diameter faces toward an outside of said ink-jet printhead.

7. The ink-jet printhead of claim 5, wherein each chamber-orifice has a truncated conical shape, wherein a lower end of said chamber orifice facing said substrate faces the corresponding ink feed hole and heater formed on the substrate and the other end having a smaller diameter faces toward an outside of said ink-jet printhead.

8. The ink-jet printhead of claim 7, wherein an expanded chamber having a predetermined diameter is disposed at the lower portion of the chamber-orifice complex hole.

9. The ink-jet printhead of claim 2, wherein said substrate comprises two channels in parallel with each other.

10. The ink-jet printhead of claim 7, wherein said substrate comprises two channels in parallel with each other

11. The ink-jet printhead of claim 2, wherein the channel has a V-shaped cross-section

12. The ink-jet printhead of claim 7, wherein the channel has a V-shaped cross-section.

13. The ink-jet printhead of claim 2, wherein the channel has a rectangular cross-section.

14. The ink-jet printhead of claim 7, wherein the channel has a rectangular cross-section.

15. A n ink-jet printhead, comprising:
a substrate having a front side and a back side opposite to said front side, wherein said back said comprises a channel along an entire length of said substrate, said channel having a bottom wherein a plurality of holes perforate through to said front side of said substrate;
a plurality of heaters, each electrically connected to a pair of signal lines, disposed on said front side of said substrate, each one of said plurality of heaters being located near at least one of said plurality of holes in said substrate; and
a nozzle plate perforated by a plurality of nozzle holes, said nozzle plate being attached to said front side of said substrate so that each one of said plurality of nozzle holes exposes corresponding ones of said plurality of heaters and so that each one of said plurality of nozzle holes exposes at least one of said plurality of holes perforating said substrate.

16. The ink-jet printhead of claim 15, wherein each one of said plurality of heaters is adjacent to two of said plurality of holes perforating said substrate, each pair of said plurality of holes perforating said substrate and each one of said plurality of heaters being disposed at a bottom of one of said plurality of holes perforating said nozzle plate.

17. The ink-jet printhead of claim 15, wherein each one of said plurality of heaters is adjacent to one of said plurality of holes perforating said substrate, each one of said plurality of holes perforating said substrate and each one of said plurality of heaters being disposed at a bottom of one of said plurality of holes perforating said nozzle plate.

18. The ink-jet printhead of claim 15, wherein each one of said plurality of heaters essentially surrounds corresponding ones of said plurality of holes perforating said substrate, said heater having an omega shape.

19. The ink-jet printhead of claim 15, said nozzle plate having a top side and a bottom side, wherein each of said plurality of nozzle holes perforating said nozzle plate at said top side has a relatively small diameter, and each of said plurality of nozzle holes at said bottom side having a relatively large diameter, said bottom side of said nozzle plate being attached to said front side of said substrate, wherein an ink chamber is formed within each one of said plurality of nozzle holes perforating said nozzle plate.

20. The ink-jet printhead of claim 19, wherein each one of said plurality of nozzle holes perforating said nozzle plate is essentially conical in shape.

21. The ink-jet printhead of claim 18, said nozzle plate having a top side and a bottom side, wherein each of said plurality of nozzle holes perforating said nozzle plate at said top side has a relatively small diameter, and each of said plurality of nozzle holes at said bottom side having a relatively large diameter, said bottom side of said nozzle plate being attached to said front side of said substrate, wherein an ink chamber is formed within each one of said plurality of nozzle holes perforating said nozzle plate.

22. The ink-jet printhead of claim 21, wherein each one of said plurality of nozzle holes perforating said nozzle plate is essentially conical in shape.

23. A method for producing an ink-jet printhead, comprising the steps of:
etching a channel into a bottom side of a silicon substrate;
etching a plurality of holes on a bottom of said channel of said substrate to perforate said substrate;
depositing a first plurality of signal lines and a second plurality of signal lines on a front side of said silicon substrate, each one of said first plurality of signal lines terminating near termination points of corresponding ones of said second plurality of signal lines, each of said terminating portions of said first and said second signal lines terminating near at least one of said plurality of holes perforating said substrate;
depositing a resistive material so as to connect terminating ends of each one of said first plurality of signal lines with corresponding ones of said plurality of second plurality of signal lines, said resistive material being near at least one of said plurality of holes perforating said substrate; and
attaching a nozzle plate perforated by a plurality of nozzle holes onto said front side of said substrate so that each one of said plurality of nozzle holes is aligned to corresponding ones of terminating ends of said first and said second signal lines, said resistive material, and at least one of said plurality of holes perforating said substrate.

24. The method of claim 23, wherein said resistive material is essentially omega in shape and surrounds corresponding ones of said plurality of holes perforating said substrate.

25. The method of claim 23, wherein said plurality of holes perforating said substrate occur in pairs so that corresponding ones of said first and said second signal lines terminate in the vicinity of a pair of holes perforating said substrate, wherein each one of said plurality of nozzle holes is positioned over said pair of holes perforating said substrate.
